(19) United States
(12) Patent Application Publication
(10) Pub. No.: US 2024/0211694 A1
(43) Pub. Date: Jun. 27, 2024

(54) KNOWLEDGE-IN-CONTEXT TOWARDS KNOWLEDGEABLE SEMI-PARAMETRIC LANGUAGE MODELS

(71) Applicant: TENCENT AMERICA LLC, Palo Alto, CA (US)

(72) Inventors: Xiaoman PAN, H3 Troy, NY (US); Wenlin YAO, Palo Alto, CA (US); Hongming ZHANG, Palo Alto, CA (US); Dian YU, Palo Alto, CA (US); Dong YU, Palo Alto, CA (US); Jianshu CHEN, Palo Alto, CA (US)

(73) Assignee: TENCENT AMERICA LLC, Palo Alto, CA (US)

(21) Appl. No.: 18/089,283

(22) Filed: Dec. 27, 2022

(51) Int. Cl. G06F 40/30; G06F 40/242; G06N 20/00

(52) U.S. Cl. CPC G06F 40/30; G06F 40/242; G06N 20/00

(57) ABSTRACT

A method including: receiving an input comprising natural language texts; selecting, via a knowledge selector, one of a plurality of knowledge categories from an external memory based on a context of the input; retrieving one or more helpful knowledge pieces from the selected knowledge category; augmenting the input using the one or more helpful knowledge pieces; feeding the augmented input into a text-to-text model; and generating an output answer based on the text-to-text model.

### TECHNICAL FIELD

The present disclosure provides a method for semi-parametric language modeling aided by Knowledge-in-Context.

### BACKGROUND

Recently, large-scale fully-parametric language models have achieved great success in solving natural language processing (NLP) tasks. However, they generally require a huge number of model parameters to store the necessary knowledge for solving multiple NLP tasks in the zero/few-shot setting. Meanwhile, their problem solving capability only emerges after reaching a certain model scale. In addition, large parametric language models are hard to adapt to the evolving world knowledge without expensive model re-training. To overcome these challenges, there has been an increasing interest in developing semi-parametric language models, where a parametric language model is augmented with an external memory containing a large amount of text chunks.

Although existing semi-parametric approaches are shown to be more effective than their much larger parametric counterparts, there remain several challenges. The first challenge is that useful knowledge pieces are generally sparsely distributed over a large textual corpus. Therefore, it is difficult to locate and retrieve the correct text chunk that contains the right knowledge to complement a particular input instance. Second, it is difficult to determine the proper text chunk granularity to cover the desired knowledge. Thus, people usually use oversized text chunks to build indexing, which makes it even harder to determine whether knowledge is contained. On the other hand, there have been a rich collection of knowledge resources such as diverse knowledge graphs, where different kinds of knowledge are densely and compactly organized in structured or semi-structured forms. The present disclosure leverages these knowledge resources to construct a semi-parametric language model, by simply using off-shelf encoders and retrievers to index and search the external memory.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

This disclosure provides a method for semi-parametric language modeling aided by Knowledge-in-Context.

According to some embodiments, there is provided a method performed by at least one processor. The method includes receiving an input comprising natural language texts. The method further includes selecting, via a knowledge selector, one of a plurality of knowledge categories from an external memory based on a context of the input. The method further includes retrieving one or more helpful knowledge pieces from the selected knowledge category. The method further includes augmenting the input using the one or more helpful knowledge pieces. The method further includes feeding the augmented input into a text-to-text model; and generating an output answer based on the text-to-text model.

According to some embodiments, an apparatus includes at least one memory configured to store program code and at least one processor configured to read the program code and operate as instructed by the program code. The program code includes receiving code configured to cause the at least one processor to receive an input comprising natural language texts. The program code further includes selecting code configured to cause the at least one processor to select, via a knowledge selector, one of a plurality of knowledge categories from an external memory based on a context of the input. The program code further includes retrieving code configured to cause the at least one processor to retrieve one or more helpful knowledge pieces from the selected knowledge category. The program code further includes augmenting code configured to cause the at least one processor to augment the input using the one or more helpful knowledge pieces. The program code further includes feeding code configured to cause the at least one processor to feed the augmented input into a text-to-text model. The program code further includes generating code configured to cause the at least one processor to generate an output answer based on the text-to-text model.

According to some embodiments, a non-transitory computer-readable storage medium, stores instructions that, when executed by at least one processor, cause the at least one processor to receive an input comprising natural language texts. The instructions further cause the at least one processor to select, via a knowledge selector, one of a plurality of knowledge categories from an external memory based on a context of the input. The instructions further cause the at least one processor to retrieve one or more helpful knowledge pieces from the selected knowledge category. The instructions further cause the at least one processor to augment the input using the one or more helpful knowledge pieces. The instructions further cause the at least one processor to feed the augmented input into a text-to-text model. The instructions further cause the at least one processor to generate an output answer based on the text-to-text model.

Additional embodiments will be set forth in the description that follows and, in part, will be apparent from the description, and/or may be learned by practice of the presented embodiments of the disclosure.

### BRIEF DESCRIPTION OF THE DRAWINGS

The above and other features and aspects of embodiments of the disclosure will be apparent from the following description taken in conjunction with the accompanying drawings, in which:

FIG. 1 is a diagram of an environment in which methods, apparatuses and systems described herein may be implemented, according to some embodiments.

FIG. 2 is a block diagram of example components of one or more devices of FIG. 1.

FIG. 3 is an overview of a KiC model architecture, according to some embodiments.

FIG. 4A is an overview of a mixture-of-experts (MoE) architecture, according to some embodiments.

FIG. 4B shows an example arrangement of an expert model, according to some embodiments.

FIGS. 5A-D contain tables and graphs of the performance of the KiC model, according to some embodiments.

FIG. 6 is a flowchart of example process 600 for semi-parametric language modeling aided by Knowledge-in-Context

### DETAILED DESCRIPTION

The following detailed description of example embodiments refers to the accompanying drawings. The same reference numbers in different drawings may identify the same or similar elements.

The following disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

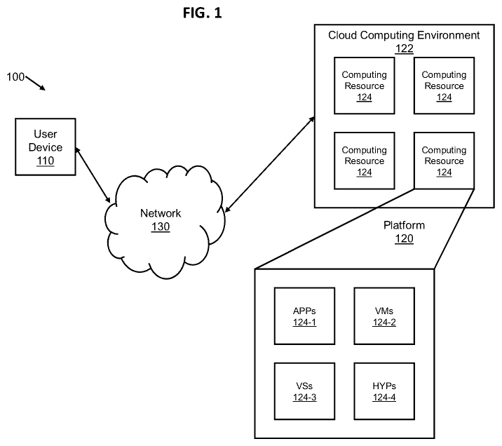

FIG. 1 is a diagram of an environment 100 in which methods, apparatuses and systems described herein may be implemented, according to embodiments.

As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g., the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (“APPs”) 124-1, one or more virtual machines (“VMs”) 124-2, virtualized storage (“VSs”) 124-3, one or more hypervisors (“HYPs”) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g., a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (“OS”). A process virtual machine may execute a single program, and may support a single process. In some implementations, the virtual machine 124-2 may execute on behalf of a user (e.g., the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g., “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 may include one or more wired and/or wireless networks. For example, the network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

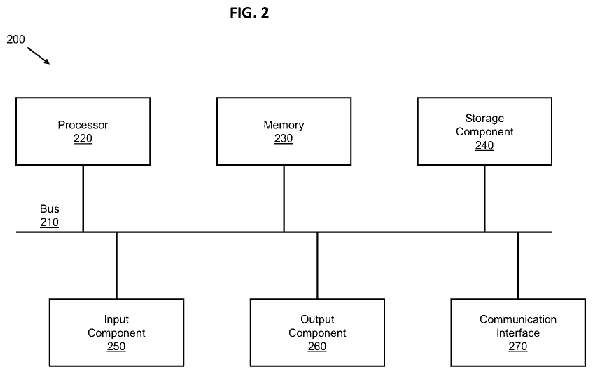

FIG. 2 is a block diagram of example components of one or more devices of FIG. 1.

A device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g., a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g., a touch screen display, a keyboard, a keypad, a mouse, a button, a switch, and/or a microphone). Additionally, or alternatively, the input component 250 may include a sensor for sensing information (e.g., a global positioning system (GPS) component, an accelerometer, a gyroscope, and/or an actuator). The output component 260 includes a component that provides output information from the device 200 (e.g., a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

Fully-parametric language models generally require a huge number of model parameters to store the necessary knowledge for solving multiple natural language tasks in zero/few-shot settings. In addition, it is hard to adapt to the evolving world knowledge without the costly model re-training. Embodiments relate to a novel semi-parametric language model architecture, Knowledge-in-Context (KiC), which empowers a parametric text-to-text language model with a knowledge-rich external memory. In some embodiments, the external memory contains six broad categories of different knowledge types: entity, dictionary, commonsense, event, script, and causality knowledge. For each input instance, the KiC model adaptively selects a knowledge type and retrieves the most helpful pieces of knowledge. The input instance along with its knowledge augmentation is fed into a text-to-text model (e.g., T5) to generate the output answer, where both the input and the output are in natural language forms after prompting. Interestingly, we find that KiC may be identified as a special mixture-of-experts (MoE) model, where the knowledge selector plays the role of a router that is used to determine the sequence-to-expert assignment in MoE. This key observation inspires the development of a novel algorithm for training KiC with an instance-adaptive knowledge selector. As a knowledge-rich semi-parametric language model, KiC only needs a much smaller parametric part to achieve superior zero-shot performance on unseen tasks. By evaluating on 40+ different tasks, the results show that KiC_{Large} with 770M parameters easily outperforms large language models (LMs) that are 4-39× larger by a large margin. Embodiments demonstrate that KiC exhibits emergent abilities at a much smaller model scale compared to the fully-parametric models.

In embodiments, a wide range of natural language tasks may benefit from adding knowledge, where different knowledge resources help with different subsets of tasks. For example, an experimental analysis shows that 31 out of 35 natural language tasks benefited from added knowledge. Interestingly, some tasks are even improved by 10%+ after adding suitable knowledge. To adaptively utilize knowledge, embodiments may exploit KiC to dynamically identify the most useful knowledge pieces for each input instance from a certain task and places them in the current context for answering the question. Some embodiments adopt a single text-to-text transformer (e.g., T5) to generate the output answer from the input. The retrieved knowledge pieces are appended to the input instance and converted into a natural language sequence with prompt templates. The input is then fed into the text-to-text model to generate the output answer (also in natural language). The major advantage of such a text-to-text paradigm is that it handles multiple natural language tasks with the same interface and can also generalize to unseen tasks. This training paradigm is suitable for the model design as it can teach the KiC model to learn how to select and use knowledge through various seen language tasks and then generalize well to use knowledge for solving unseen tasks. The experimental analysis further shows that such instance-adaptive (context-dependent) knowledge augmentation is critical to the success of KiC model. However, due to the inherent discrete nature, it is difficult to train KiC in a fully differentiable manner to select the correct knowledge category for each instance. To solve this problem, the KiC may be reformulated as a special mixture-of-experts (MoE) model, where the knowledge selector is identified as the router that is used to determine the sequence-to-expert assignment in MoE. Furthermore, the memory partition corresponding to each knowledge category together with the text-to-text model may be recognized as a special semi-parametric expert in MoE. This key observation inspires the development of a novel learning algorithm to train KiC with instance-adaptive knowledge selection capabilities.

In some embodiments, the KiC language model augments a parametric text-to-text Transformer (backbone) model with a knowledge-rich external memory. Overall, KiC consists of the following modules: (i) a parametric text-to-text backbone, (ii) an external knowledge memory with a retriever, and (iii) a knowledge selector. For each input instance, the knowledge selector first selects a particular knowledge category based on the input context and then retrieves the most helpful knowledge pieces for solving the current problem. The retrieved knowledge is used to complement the input context via concatenation, which is further converted into a natural language sequence using prompt templates. Then, the prompted textual inputs are fed into the text-to-text backbone model, which generates the output solution in natural language. The text-to-text backbone model may be any encoder-decoder models (e.g., T5, BART) or decoder-only models (e.g., GPT, PaLM). For convenience and without loss of generality, T5 is the backbone model throughout the disclosure.

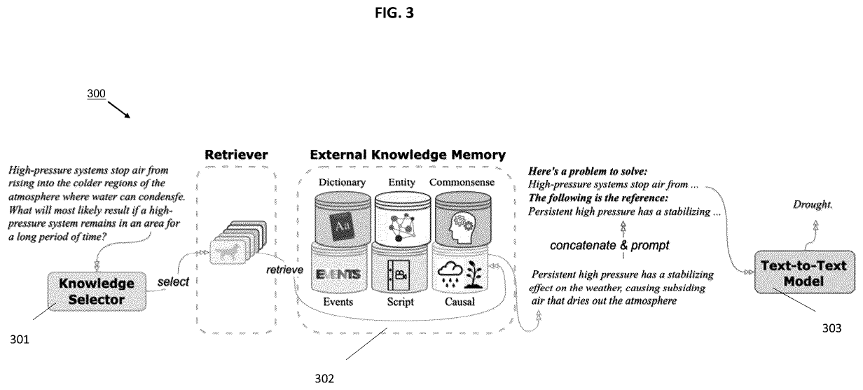

FIG. 3 is an overview of a KiC model architecture 300 according to some embodiments. The KiC model 300 is augmented with a knowledge-rich memory 302 that contains diverse categories of knowledge. For each input instance, KiC first selects a particular knowledge category using knowledge selector 301 and retrieves the most helpful knowledge pieces to augment the input. It then feeds the prompted input into a text-to-text backbone module 303 (e.g., T5) to generate the output answer.

A significant advantage of semi-parametric models over fully-parametric ones is that semi-parametric models may flexibly change the knowledge resources. Structured knowledge resources may often provide more relevant and accurate knowledge than plain text. In some embodiments, the following popular representative knowledge resources are included.

| | Dictio- | Common- | | | | |
|---|---|---|---|---|---|---|
| | nary | sense | Entity | Event | Script | Causal |
| # instances | 1.8M | 600K | 257M | 6.4M | 248K | 314M |
| type | human | human | human | auto | auto | auto |

Dictionary: Dictionary is consider (lexical) knowledge, which records definitions and example sentences of English words. In some embodiments the largest open-source dictionary Wiktionaryl is leveraged as the lexical knowledge resource. The Wiktionary dump dated Apr. 30 2022 that contains 1.3M word senses and 470K example sentences for 1M words/phrases is used.

Commonsense: Besides the lexical knowledge, commonsense knowledge is included from ConceptNet (Liu & Singh, 2004), which covers broad knowledge in daily life. In ConceptNet, all knowledge are in the format of triplets with human-defined relations (e.g., “bird”-CAPABLEOF-“fly”). The core 600K high-quality triplets are included.

Entity: Named entity knowledge is covered in Wikipedia and Wikidata. Given an entity (e.g., “United States”), each property of it is converted to be a separate triplet (e.g., “United States”-CAPITAL-“Washington D.C.”) such that the format is same as other knowledge resources. In addition to structured entity knowledge, all Wikipedia sentences related to the entity are included.

Event: Knowledge about daily events are covered with human-constructed (i.e., ATOMIC and GLUCOSE) or auto-extracted event knowledge graphs (i.e., ASER). Similar to commonsense knowledge, all event knowledge graphs store knowledge in the triplet format, where relations are human-defined or discourse relations, the head and the tail are events. An ASER example is “I am hungry”-BEFORE-“I eat food”.

Script: Besides the knowledge covered by pre-defined relations, script knowledge is also included to cover more complex ones. 325K pieces of script knowledge is used, each containing a pair of related verbal and nonverbal information (e.g., “Of course not. I'm going . . . to his house.” and “thinking”) as well as the context where they situate. Given a query, the most relevant scenario is retrieved as external knowledge.

Causality: The last external knowledge resource included is the auto-extracted causal knowledge CausalBank, which collects large-scale English sentences expressing cause-effect relations. CausalBank consists of 133M because mode sentences (i.e., sentences captured by 12 patterns such as “because”, “caused by”, etc.) and 181M therefore mode sentences (i.e., sentences captured by 19 patterns such as “therefore”, “result in”, etc.).

Although the effectiveness of knowledge such as entity and dictionary knowledge has been demonstrated on a wide range of tasks, other types of knowledge such as commonsense and script knowledge are only used for carefully selected tasks that tend to require these types of knowledge.

In some embodiments, the target word is used as the key and definition as the value for dictionary knowledge and every utterance as the key and the background context as the value for script knowledge. To effectively retrieve knowledge from the other four knowledge resources, dense retrieval techniques are used. All knowledge pieces are converted into natural language sentences as values (e.g., I am hungry before I eat food.) and then encoded into dense vectors as keys using a SOTA sentence encoder MPNet. Given a query, the retriever encodes it with the same sentence encoder model and then retrieves the most relevant knowledge with the maximum inner product search (MIPS) search which is able to reduce search complexity from O(n) to O(log n). In KiC, SCaNN is employed as the MIPS search algorithm.

In embodiments, for a particular task, some knowledge categories help the performance while others might hurt. For this reason, it may be desirable to dynamically select the correct knowledge type in order to facilitate the solution of the problem. In the embodiments, instead of using task-dependent knowledge selection, a more fine-grained instance-dependent strategy is considered: The knowledge is adaptively chosen based on each input instance.

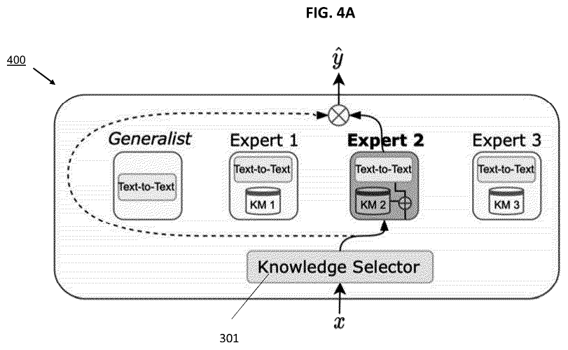

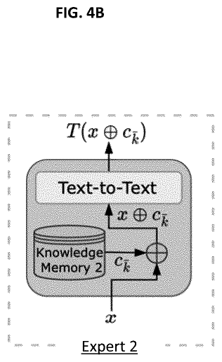

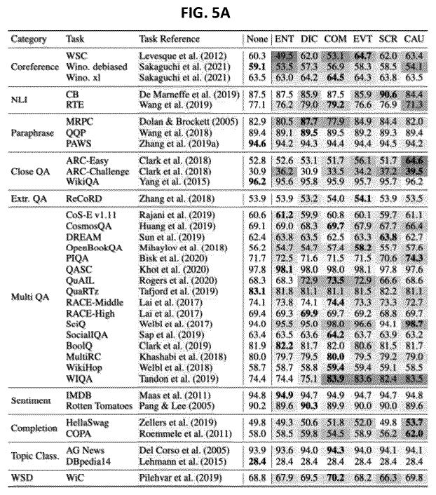

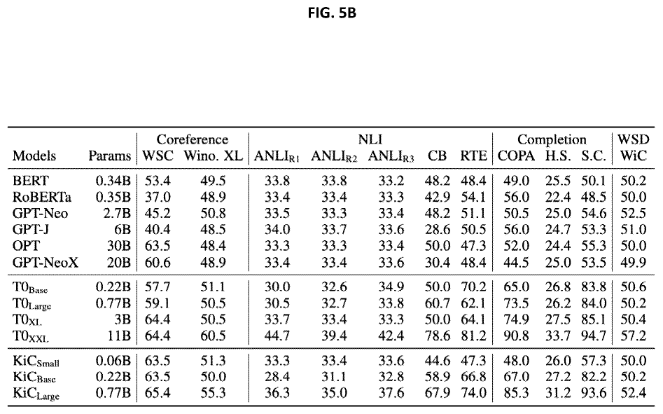

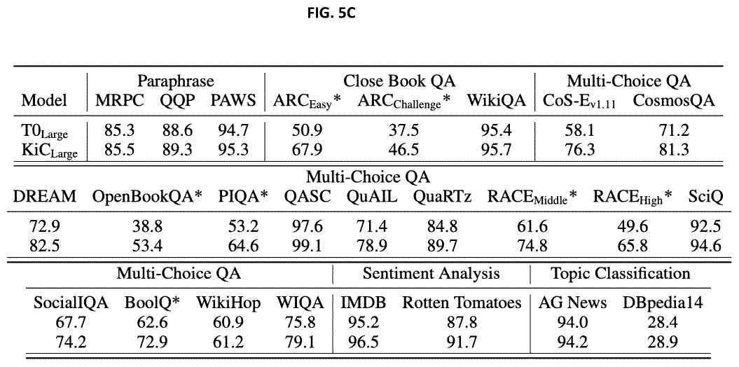

FIG. 4A shows how the KiC model may be equivalently formulated as a mixture-of-experts (MoE) architecture 400. The knowledge selector 301 may be identified as a router that is used to determine the sequence-to-expert assignment in MoE. Each expert, for example Expert 1, Expert 2, and Expert 3, is made up of the (shared) text-to-text model and the external memory of a particular knowledge category, illustrated as knowledge memory (KM) 1, KM 2, and KM3. Therefore, each expert is in itself a stand-alone semi-parametric language model specialized in a certain type of knowledge. To allow the option of not using any knowledge, a “generalist” module is included, which is the (shared) text-to-text model alone. FIG. 4B shows an example arrangement of Expert Model 2, according to embodiments.

The discrete decision made by the knowledge selector 301 will seep into the overall neural architecture in the form of a discrete latent variable. There could be several alternative methods (such as reinforcement learning) for learning the model with discrete latent variables. In some embodiments, a simple yet effective approach is developed for learning KiC in a fully-differentiable end-to-end manner. The key idea is based on an important observation that KiC may be reformulated as a special one-layer mixture-of-experts architecture. The knowledge selector 301 may be identified as the router that is used to determine the sequence-to-expert assignment in MoE. This is slightly different from the settings of the recent MoE works, where their routers perform token-to-expert assignments. Meanwhile, each expert is made up of the text-to-text module together with a particular category of knowledge memory. Interestingly, each expert is in itself a stand-alone semi-parametric language model, which retrieves a particular kind of knowledge from its own memory to augment its inputs. In other words, each expert may be understood as a specialist with expertise in a specific knowledge category. A special expert named generalist is included, which is used to handle situation where there is no need for knowledge from the memory. Furthermore, due to the original KiC design, the text-to-text modules in all the experts (and the generalist) share the same model parameters with the only difference being the non-parametric parts (i.e., the knowledge memories).

Inspired by the above KiC-MoE equivalence, a fully-differentiable learning strategy is developed for KiC by leveraging existing MoE learning approaches. In some embodiments, the knowledge selector S(x) is modeled as a (K+1)-way classifier, which outputs a (K+1)-dimensional normalized probability vector. Its k-th element, denoted as Sk(x), represents the probability of choosing the k-th knowledge category for k=0, 1, . . . , K, where k=0 represents the choice of generalist (i.e., no external knowledge). Let T (·) denote the text-to-text transformer and ck be the knowledge retrieved from the k-th category. in KiC, the top-1 knowledge category is selected according to S(x) and the output is computed. Currently, only the top-1 knowledge selection (routing) is considered for simplicity and the generalization is left to top-n selection as future work. Finally, similar to MoE, an auxiliary load balancing loss is added together with the standard cross-entropy loss during KiC learning.

Without a load balancing term, the knowledge selector 301 tends to select only one knowledge category throughout the entire training process, which was also observed in MoE learning. There could be different choices of the load balancing loss, which encourage the diversity of knowledge selection in different ways based on S(x). Without loss of generality, the same load balancing loss is used as in Swith Transformer.

The above KiC-MoE equivalence may also lead to interesting observations that could potentially benefit the studies of both semi-parametric language models and MoEs. For example, in MoE works, the experts are generally designed to be different parametric neural modules (e.g., different MLPs). However, the present disclosure shows that this may not be the only option: different experts may be constructed using the same parametric module but with different inputs.

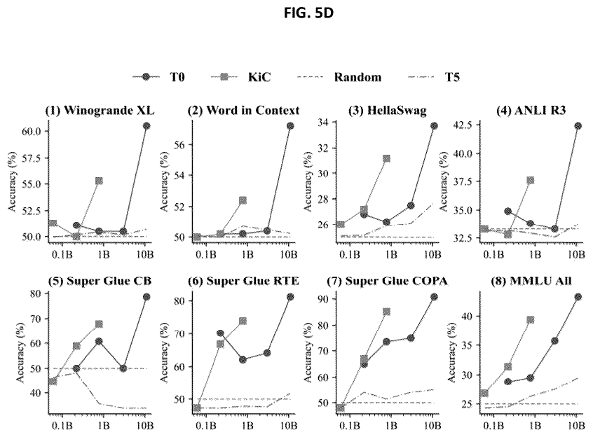

To verify the assumption that external knowledge resources may facilitate LMs in general language understanding and see effects of using different types of knowledge, single-task fine-tuning experiments were conducted on a wide range of downstream tasks, according to embodiments. FIG. 5A is a table of 35 tasks evaluated and classified into 10 categories following the P3 task categorization framework. For each knowledge type (each column), all retrieved knowledge texts are appended in front of the input sentence by adding a special token in between. Next, the augmented input sentences are fed into the standard text-to-text model (T5) to generate the target answer for optimization, where training instances are from each single task. FIG. 5A shows that the model performances on 30 out of 35 tasks are improved after adding at least one type of knowledge, which demonstrates the effectiveness of using high-quality external knowledge. Based on these results, KiC is leveraged to dynamically identify the most useful knowledge pieces to adaptively utilize knowledge.

The main model KiC is initialized with T5-LM-adapt, an improved version of T5 that continues training T5 for additional 100K steps on the LM objective to leverage its ability to generate natural language. Similar to T0, the KiC model is trained on a mixture of multiple tasks (39 tasks in total) by combining and shuffling all training instances from different tasks (8.4M in total) and predict on unseen (held-out) tasks to evaluate zero-shot generalization ability. The final KiCLarge model is trained using 128 NVIDIA V100 GPUs for 42 hours.

FIG. 5B is a table showing the results of the KiC model evaluated on two groups of zero-shot datasets. 1) Held-out tasks of P3 contain two coreference tasks, three NLI tasks, three sentence completion tasks and one word sense disambiguation (WSD) task. Results show that the KiCLarge model outperforms all zeroshot baseline models (e.g., GPT-NeoX, OPT) that are 25-38× larger. Moreover, KiCLarge beats TOXL that has 3B parameters on all 9 tasks by a large margin with our adaptive knowledge selector and only 0.77B parameters. 2) Massive Multitask Language Understanding (MMLU) benchmark is designed to measure knowledge acquired in model pretraining. MMLU covers 57 subjects under four categories, i.e., STEM, Humanities, Social Sciences and Other. Comparison with SOTA LMs are shown in the following table. The KiCLarge beats all fine-tuning baseline models ROBERTaLarge and GPT-2 without using any training data from MMLU. Surprisingly, KiCLarge achieves an average performance of 39.4% using only 0.77B parameters, which is just 4.5% below GPT-3 that has 175B parameters (227× larger) plus 5 training examples.

To see whether the KiC learning may help with multi-tasking training, T0Large is reproduced with the same collection of tasks and evaluated KiCLarge on the validation set of each in-domain task. FIG. 5C is a table showing the results of the evaluation. Here, in-domain tasks may be divided into two groups—tasks used in multitask training and tasks not used in multitask training but within the observed task category. Again, KiCLarge outperforms T0Large, with significant improvement on in-domain unseen tasks (tasks with *) such as Race and BoolQ and knowledge-intensive tasks such as CosmosQA and DREAM. The results demonstrate the superiority of the proposed KiC learning in multi-tasking training.

Language models usually may only perform a near random zero/few-shot performance when they are small but achieves a substantial performance jump when they reach a certain critical threshold of scale (size). A language model is generally considered superior if it can show emerging behavior at a smaller model scale. Therefore, the KiC model is compared with T5 and T0 on held-out tasks to see how performance change with respect to their model sizes. FIG. 5D contains graphs that compare the performance of the KiC model with T5 and TO. T5 is around random guess when the model is below 11B. TO is better than T5 as it shows emerging behavior when it increases from 3B to 11B. Surprisingly, the KiC model shows emerging behavior when it increases from 0.22B to 0.77B, which demonstrates that the semi-parametric model may achieve the same language understanding capacity using much fewer parameters with the help of adaptive knowledge selector and external knowledge.

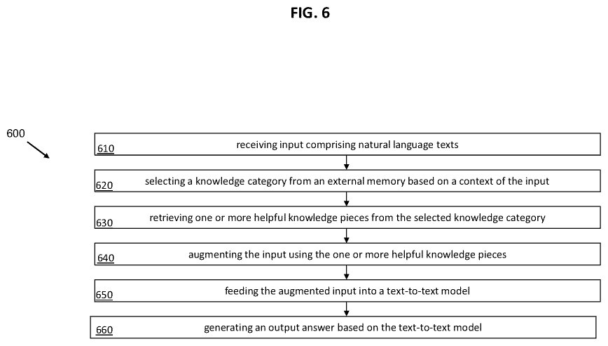

FIG. 6 is a flowchart of example process 600 for semi-parametric language modeling aided by Knowledge-in-Context. In some implementations, one or more process blocks of FIG. 6 may be performed by any of the elements discussed above.

As shown in FIG. 6, process 600 include receiving an input comprising natural language texts (block 610).

As further shown in FIG. 6, the process 600 may include selecting, via a knowledge selector, one of a plurality of knowledge categories from an external memory based on a context of the input (block 620).

As further shown in FIG. 6, the process 600 may include retrieving one or more helpful knowledge pieces from the selected knowledge category (block 630).

As further shown in FIG. 6, the process 600 may include augmenting the input using the one or more helpful knowledge pieces (block 640).

As further shown in FIG. 6, the process 600 may include feeding the augmented input into a text-to-text model (block 650).

As further shown in FIG. 6, the process 600 may include generating an output answer based on the text-to-text model (block 660).

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium may be a tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local region network, a wide region network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local region network (LAN) or a wide region network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, implement the operations specified in the flowchart and/or block diagram block or blocks. These computer readable program instructions may also be stored in a computer readable storage medium that may direct a computer, a programmable data processing apparatus, and/or other devices to operate in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the operations specified in the flowchart and/or block diagram block or blocks.

The flowchart and block diagrams in the figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical operation(s). The method, computer system, and computer readable medium may include additional blocks, fewer blocks, different blocks, or differently arranged blocks than those depicted in the Figures. In some alternative implementations, the operations noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified operations or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method executed by at least one processor, the method comprising:
receiving an input comprising natural language texts;
selecting, via a knowledge selector, one of a plurality of knowledge categories from an external memory based on a context of the input;
retrieving one or more helpful knowledge pieces from the selected knowledge category;
augmenting the input using the one or more helpful knowledge pieces;
feeding the augmented input into a text-to-text model; and
generating an output answer based on the text-to-text model.

2. The method according to claim 1, wherein both the input and the output answer are in natural language forms after prompting.

3. The method according to claim 1, wherein the plurality of knowledge categories comprises an entity knowledge category, a dictionary knowledge category, a commonsense knowledge category, an event knowledge category, a script knowledge category, and a causality knowledge category.

4. The method according to claim 1, further comprising adapting the knowledge selector based on an input instance.

5. The method according to claim 1, wherein retrieving the one or more helpful knowledge pieces from the selected knowledge category comprises:
converting the one or more helpful knowledge pieces into natural language sentences as values; and
encoding the natural language sentences into dense vectors as keys using a sentence encoder.

6. The method according to claim 1, wherein the knowledge selector determines a sequence-to-expert assignment in a mixture-of-experts (MoE) architecture, the MoE architecture comprising a plurality of experts.

7. The method according to claim 6, wherein each expert of the plurality of experts is a stand-alone semi-parametric language model comprising the text-to-text model and one of the plurality of knowledge categories.

8. An apparatus comprising:
at least one memory configured to store program code; and
at least one processor configured to read the program code and operate as instructed by the program code, the program code comprising:
receiving code configured to cause the at least one processor to receive an input comprising natural language texts;
selecting code configured to cause the at least one processor to select, via a knowledge selector, one of a plurality of knowledge categories from an external memory based on a context of the input;
retrieving code configured to cause the at least one processor to retrieve one or more helpful knowledge pieces from the selected knowledge category;
augmenting code configured to cause the at least one processor to augment the input using the one or more helpful knowledge pieces;
feeding code configured to cause the at least one processor to feed the augmented input into a text-to-text model; and
generating code configured to cause the at least one processor to generate an output answer based on the text-to-text model.

9. The apparatus according to claim 8, wherein both the input and the output answer are in natural language forms after prompting.

10. The apparatus according to claim 8, wherein the plurality of knowledge categories comprises an entity knowledge category, a dictionary knowledge category, a commonsense knowledge category, an event knowledge category, a script knowledge category, and a causality knowledge category.

11. The apparatus according to claim 8, wherein the program code further includes adapting code configured to cause the at least one processor to adapt the knowledge selector based on an input instance.

12. The apparatus according to claim 8, wherein the retrieving code is further configured to cause the at least one processor to:
convert the one or more helpful knowledge pieces into natural language sentences as values; and
encode the natural language sentences into dense vectors as keys using a sentence encoder.

13. The apparatus according to claim 8, wherein the program code further includes determining code configured to cause the at least one processor to determine, via the knowledge selector, a sequence-to-expert assignment in a mixture-of-experts (MoE) architecture, the MoE architecture comprising a plurality of experts.

14. The apparatus according to claim 13, wherein each expert of the plurality of experts is a stand-alone semi-parametric language model comprising the text-to-text model and one of the plurality of knowledge categories from the external memory.

15. A non-transitory computer-readable storage medium, storing instructions, which, when executed by at least one processor, cause the at least one processor to:
receive an input comprising natural language texts;
select, via a knowledge selector, one of a plurality of knowledge categories from an external memory based on a context of the input;
retrieve one or more helpful knowledge pieces from the selected knowledge category;
augment the input using the one or more helpful knowledge pieces;
feed the augmented input into a text-to-text model; and
generate an output answer based on the text-to-text model.

16. The non-transitory computer-readable storage medium according to claim 15, wherein both the input and the output answer are in natural language forms after prompting.

17. The non-transitory computer-readable storage medium according to claim 15, wherein the external memory covers six broad knowledge categories including: entity, dictionary, commonsense, event, script, and causality.

18. The non-transitory computer-readable storage medium according to claim 15, the instructions further cause the at least one processor to adapt the knowledge selector based on an input instance.

19. The non-transitory computer-readable storage medium according to claim 15, wherein the instructions that cause the at least one processor to retrieve the one or more helpful knowledge pieces from the selected knowledge category further cause the at least one processor to:
convert the one or more helpful knowledge pieces into natural language sentences as values; and
encode the natural language sentences into dense vectors as keys using a sentence encoder.

20. The non-transitory computer-readable storage medium according to claim 15, wherein the instructions further cause the at least one processor to determine, via the knowledge selector, a sequence-to-expert assignment in a mixture-of-experts (MoE) architecture, the MoE architecture comprising a plurality of experts.
